(19) United States
(12) Patent Application Publication
(10) Pub. No.: US 2019/0028971 A1
(43) Pub. Date: Jan. 24, 2019

(54) NETWORK COMMUNICATION FREQUENCY ADJUSTMENT

(71) Applicant: Google Inc., Mountain View, CA (US)

(72) Inventor: Jibing Wang, Saratoga, CA (US)

(21) Appl. No.: 15/657,738

(22) Filed: Jul. 24, 2017

(51) Int. Cl. H04W 52/02

(52) U.S. Cl. CPC H04W 52/0251; H04W 88/02; H04W 52/0274

(57) ABSTRACT

Methods, systems, and apparatus, including computer programs encoded on a computer storage medium, for adjusting network communication frequency are disclosed. In one aspect, a method includes the actions of determining, by a mobile device, that the mobile device is connected to a network. The actions further include accessing, by the mobile device, first sensor data that was collected by a sensor of the mobile device. The actions further include determining, by the mobile device, a user proximity to the mobile device based on analysis of the first sensor data. The actions further include selecting, by the mobile device, a first time interval based on the determined user proximity to the mobile device. The actions further include communicating, by the mobile device, with the network according to the first time interval that was selected based on the determined user proximity to the mobile device.

### TECHNICAL FIELD

This specification generally relates to data communications between a client device and network access point.

### BACKGROUND

A data network is a digital telecommunications network which allows nodes to share resources. Networked computing devices may exchange data with each other using a data link. The connections between nodes may be established using either cable media or wireless media.

### SUMMARY

The battery life of a mobile device may be an important metric. An end user may wish to have a mobile device with a long battery life in order to use the device for an entire day without having to recharge the battery. A mobile device manufacturer may wish to market a mobile device with a long battery life in order to drive sales. A mobile device operating system developer may wish to market an operating system that uses the hardware of a mobile device efficiently and maximizes battery life. Having a long battery life may come with some compromises, some of which may be unacceptable to the end user. For example, an end user may not be interested in a mobile device with a long battery life if the screen is dim and pixelated. An end user may find it acceptable if a mobile device delays notifications in instances where the end user is not interested in receiving prompt notifications.

To take advantage of the notification compromise, an operating system developer may use the sensors of a mobile device to determine if there is likely an individual near the mobile device. If the system detects an individual near the mobile device, then the developer may design the system to check the network for data at a frequency that is low enough to provide the user with a good user experience. While frequently checking the network for data may use more battery, the user may find this an acceptable trade off because the user does not want to receive delayed messages, phone calls, notifications, etc. from the network.

If the system detects that an individual is likely not near the mobile device, then the developer may design the system to check the network for data at a frequency that is high enough to present any notifications that have been received somewhat recently, but low enough to preserve battery power given that there may not be a user nearby to check the mobile device for new notifications. The user may find this to be an acceptable trade off because the user may be comfortable receiving delayed notifications if the user is not near the mobile device.

To adjust the frequency at which the mobile device checks the network for new data, the operating system developer may design the system to access data of a proximity detector that may be incorporated into the mobile device. The proximity detector may provide information related to the proximity of nearby individuals. The system may use this proximity information to calculate an estimated distance that an individual may be from the mobile device. The closer to the mobile device that an individual is detected the more frequently that the mobile device checks the network for new information.

For example, an operating system may access data from the proximity detector, process that proximity data, and determine that an individual is likely within two meters of the mobile device. The operating system may set the frequency at which the mobile device checks the network for new data to be one hundred milliseconds. An operating system may later access data from the proximity detector, process the new proximity data, and determine that an individual is likely not within ten meters of the mobile device. The proximity detector may have a nominal range of ten meters. The operating system may update the frequency at which the mobile device checks the network for new data to be five hundred milliseconds.

According to an innovative aspect of the subject matter described in this application, a method for adjusting network communication frequency includes the actions of determining, by a mobile device, that the mobile device is connected to a network; accessing, by the mobile device, first sensor data that was collected by a sensor of the mobile device; determining, by the mobile device, a user proximity to the mobile device based on analysis of the first sensor data; selecting, by the mobile device, a first time interval based on the determined user proximity to the mobile device; and communicating, by the mobile device, with the network according to the first time interval that was selected based on the determined user proximity to the mobile device.

These and other implementations can each optionally include one or more of the following features. The actions further include accessing, by the mobile device, second sensor data that was collected by the sensor of the mobile device; determining, by the mobile device, a second user proximity to the mobile device based on analysis of the second sensor data; selecting, by the mobile device, a second, different time interval based on the determined second user proximity to the mobile device; and communicating, by the mobile device, with the network according to the second, different time interval that was selected based on the determined second user proximity to the mobile device. The action of determining the second user proximity to the mobile device based on analysis of the second sensor data includes determining that the second user proximity is less than a threshold proximity. The action of selecting the second, different time interval based on the determined second user proximity to the mobile device includes selecting the second, different time interval based on determining that the second user proximity is less than the threshold proximity.

The action of determining the user proximity to the mobile device based on analysis of the first sensor data includes determining that the user proximity is greater than a threshold proximity. The action of selecting the first time interval based on the determined user proximity of the individual to the mobile device includes selecting the first time interval based on determining that the user proximity is greater than the threshold proximity. The action of selecting the first time interval is performed utilizing a function that receives as input the determined user proximity and outputs a time interval value. The action of communicating with the network according to the first time interval that was selected based on the determined user proximity to the mobile device includes activating a radio of the mobile device to receive data transmitted to the mobile device over the network. The mobile device communicates with the network to determine whether data is available for the mobile device. The action of determining whether data is available for the mobile device includes determining that data is available for the mobile device. The actions further include transmitting, by the mobile device and to the network, a request for the data; and receiving, by the mobile device, the data.

The actions further include before communicating with the network according to the first time interval that was selected based on the determined user proximity to the mobile device, transmitting, by the mobile device and to the network, an indication of the first time interval to cause a computing system associated with the network to transmit pages according to the first time interval. The sensor includes a proximity sensor. The mobile device is in a low power mode. The mobile device selects the first time interval based on the mobile device being in the low power mode. The mobile device communicates with the network according to the first time interval based on the mobile device being in the low power mode. The action of communicating with the network according to the first time interval that was selected based on the determined user proximity to the mobile device includes repeatedly activating a radio of the mobile device to receive data transmitted to the mobile device over the network. A time period between activations of the radio corresponds to the first time interval. The radio is inactive between activations.

Other embodiments of this aspect include corresponding systems, apparatus, and computer programs recorded on computer storage devices, each configured to perform the operations of the methods.

Particular embodiments of the subject matter described in this specification can be implemented so as to realize one or more of the following advantages. A mobile device may preserve battery life by limiting communications with the network when a user is not near the mobile device. A mobile device may decrease a load on the processor by limiting communications with the network when a user is not near the mobile device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example system of two mobile devices communicating at different time intervals with a network based on the proximity of individuals.

FIG. 2 is an example system that is configured to adjust a time interval that the system communicates with a network.

FIG. 3 is a flowchart of an example process for adjusting a time interval that a mobile device communicates with a network.

FIG. 4 is an example of a computing device and a mobile computing device.

Like reference numbers and designations in the various drawings indicate like elements.

### DETAILED DESCRIPTION

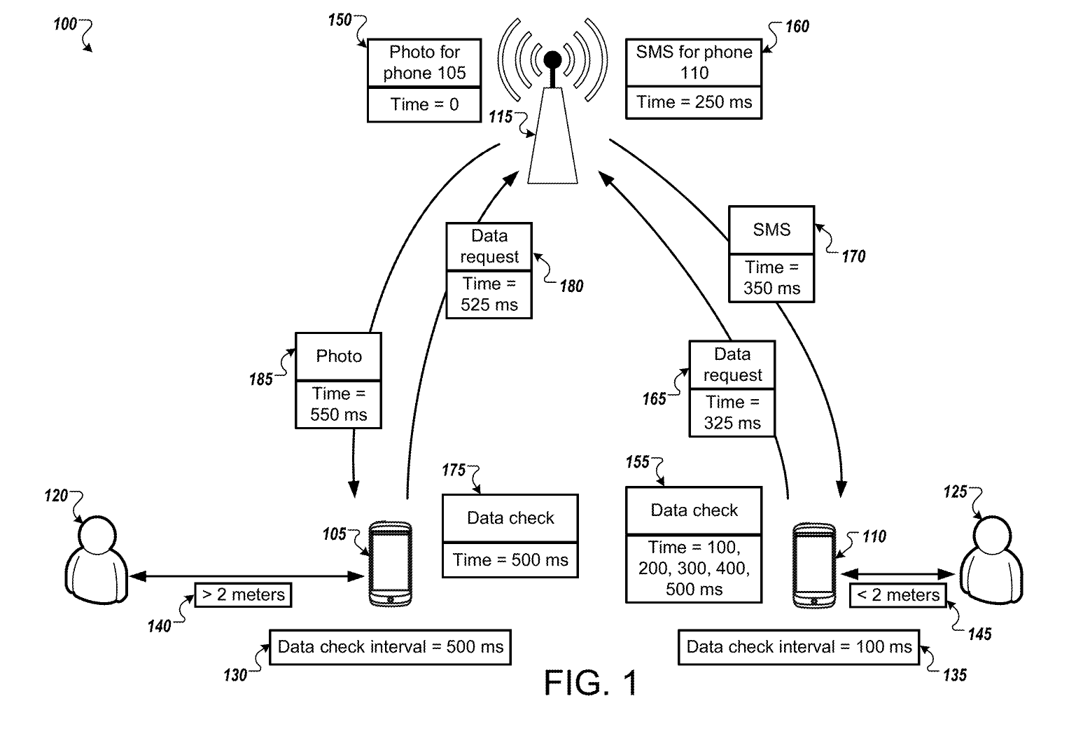

FIG. 1 is an example system 100 of two mobile devices 105 and 110 communicating at different time intervals with a network 115 based on the proximity of individuals. Briefly, and as described in more detail below, mobile device 105 detects the proximity 140 of individual 120. Based on the proximity 140 of the individual 120 to the mobile device 105, the mobile device 105 adjusts a data check interval 130 for checking the network 115 for new data. Similarly, the mobile device 110 detects the proximity 140 of the individual 125. Based on the proximity 145 of the individual 125 to the mobile device 110, the mobile device 110 adjusts a data check interval 135 for checking the network 115 for new data. The data check interval 135 is shorter than the data check interval 130 because the mobile device 110 is closer to the individual 125 than the mobile device 105 is to the individual 120.

In the example shown in FIG. 1, mobile devices 105 and 110 are connected to the network 115. The network 115 is configured to transmit and receive data from the connected mobile devices. The network 115 may have data to transmit to a mobile device and provides an indicator to the mobile device that the network 115 has data to deliver to the mobile device. The data may be a voice call, a text message, an email, a photo, a notification that a friend posted on social media, or any other similar type of data. The network 115 may continuously broadcast that it has data available for a mobile device or may periodically broadcast at an interval such as fifty milliseconds.

To check the network 115 for new data, the mobile devices 105 and 110 may be configured to activate a receiver. Activating the receiver allows the mobile devices 105 and 110 to receive a transmission from the network 115. To preserve battery power, a mobile device may not be configured to continuously check the network 115 for new data. Instead, a mobile device may be configured to periodically check the network 115 for new data. For example, if the network 115 is a wifi network, the mobile devices 105 and 110 may check the wifi network 115 for data according to a DTIM (delivery traffic indication map) interval. For DTIM1, a mobile device may check the wifi network 115 every one hundred milliseconds. For DTIM5, a mobile device may check the wifi network 115 every five hundred milliseconds. The DTIM interval may also be a similar time interval. If the network 115 is an LTE network, the mobile devices 105 and 110 may check the LTE network 115 for data according to a DRX (discontinuous reception) cycle time. The DRX cycle time may be one hundred milliseconds, five hundred milliseconds, or any other similar cycle time.

In the example shown in FIG. 1, mobile device 105 uses a proximity sensor to detect the presence of any individuals in proximity of the mobile device 105. Based on data received from the proximity sensor, the mobile device 105 may determine that the proximity 140 of individual 120 is greater than 2 meters from the mobile device 105. The mobile device 105 may set the data check interval 130 to five hundred millisecond based on the individual 120 being greater than 2 meters from the mobile device 105. A data check interval 130 of five hundred milliseconds may correspond to DTIM5.

Similarly, mobile device 110 uses a proximity sensor to detect the presence of any individuals in proximity of the mobile device 110. Based on data received from the proximity sensor, the mobile device 110 may determine that the proximity 145 of individual 125 is less than 2 meters from the mobile device 110. The mobile device 110 may set the data check interval 135 to one hundred millisecond based on the individual 125 being less than 2 meters from the mobile device 110. A data check interval 135 of one hundred milliseconds may correspond to DTIM1.

FIG. 1 includes a number of timing blocks that indicate the relative timing of the sequence of events related to the data transmissions between the mobile device 105 and the network 115 and between the mobile device 110 and the network 115. At time=0, the network receives a photo for mobile device 105. The photo may be sent from another user. For example, the other user may send a photo as an MMS message or through a chat application to the user of mobile device 105. The network 115 broadcasts to mobile device 105 an indication 150 that the network 115 has data ready to transmit to the mobile device 105. Unless the mobile device 105 activates the mobile device's receiver, then the mobile device 105 may be unable to receive the indication 150 that the network 115 has data ready to transmit to the mobile device 105.

At time=100 milliseconds, the mobile device 110 activates a receiver 155 that is configured to receive data broadcasts from the network 115. The mobile device 110 activates the receiver 155 at time=100 milliseconds because the data check interval 135 for mobile device 110 is one hundred milliseconds. At time=100 milliseconds, the network 115 is not transmitting data indicating that data is available for mobile device 110. The mobile device 110 activates the receiver 155 again at time=200 milliseconds. Again, the network 115 is not transmitting data indicating that data is available for mobile device 110.

At time=250 milliseconds, the network 115 receives an SMS message for mobile device 110. The SMS message may be sent from another user. The network 115 broadcasts to mobile device 110 an indication 160 that the network 115 has data ready to transmit to the mobile device 110. Unless the mobile device 110 activates the mobile device's receiver, then the mobile device 110 may be unable to receive the indication 160 that the network 115 has data ready to transmit to the mobile device 110.

At time=300 milliseconds, the mobile device 110 activates the receiver 155 of the mobile device 110. The receiver 155 of the mobile device 110 receives the indication from the network 115 that data is available for mobile device 110. In some implementations, the indication 160 may not describe the type of data available on the network 115. For example, the indication 160 may only include data indicating that some type of data is available on network 115. In some implementations, the indication 160 may describe the type of data available on the network 115. For example, the indication 160 may include that the data is an SMS message.

At time=325 milliseconds, the mobile device 110 may activate a transmitter to send a data request 165 to the network 115. The data request 165 may be for the network 115 to send the data that corresponds to the indication 160. In some implementations, the data request 165 may request that the network 115 send any data that is available for the mobile device 110. The network 115 receives the data request 165. At time=350 milliseconds, the network 115 transmits the SMS message 170 to the mobile device 110. The mobile device 115 may display a notification that the mobile device 110 received the SMS message 170. For example, the screen may display a notification that the mobile device 110 received a new SMS message 170. Additionally or alternatively, the mobile device 110 may play an audio file to indicate receipt of the SMS message 170. The individual 125 may react to the notification and view the SMS message 170 on the mobile device.

At time=400 milliseconds, the mobile device 110 activates the receiver 155 again. The network 115 is not transmitting data indicating that data is available for mobile device 110. The network 115 already transmitted the SMS message 170 to the mobile device 110. The network 115 has not received any additional data for the mobile device 110.

At time=500 milliseconds, the mobile device 110 again activates the receiver 155. The network 115 is not transmitting data indicating that data is available for mobile device 110. Also at time=500 milliseconds, the mobile device 105 activates the receiver 175. The receiver 175 of the mobile device 105 receives the indication 150 from the network 115 that data is available for mobile device 105. In some implementations, the indication 150 may not describe the type of data available on the network 115. For example, the indication 150 may only include data indicating that some type of data is available on network 115. In some implementations, the indication 150 may describe the type of data available on the network 115. For example, the indication 150 may include that the data is a photo.

At time=525 milliseconds, the mobile device 105 may activate a transmitter to send a data request 180 to the network 115. The data request 180 may be for the network 115 to send the data that corresponds to the indication 150. In some implementations, the data request 150 may request that the network 115 send any data that is available for the mobile device 105. The network 115 receives the data request 180. At time=550 milliseconds, the network 115 transmits the photo 185 to the mobile device 105. The mobile device 115 may display a notification that the mobile device 105 received the photo 185. For example, the screen may display a notification that the mobile device 105 received a new photo 180 (e.g., a text message that indicates that the mobile device 105 has received a photo, and/or a representation of the photo). Additionally or alternatively, the mobile device 105 may play an audio file to indicate receipt of the photo 180. The individual 120 may react to the notification and view the photo 180 on the mobile device 105.

In some implementations, the mobile device 105 or 110 may provide an indication to the network 115 of a change to the time interval at which the mobile device 105 or 110 activates a receiver to receive any indications of data from the network 115. For example, if the network 115 is an LTE network, then the mobile device 105 may provide an indication to the network 115 that the time interval, or DRX cycle, is one hundred milliseconds. The mobile device 110 may provide an indication to the network 115 that the time interval, or DRX cycle, is five hundred milliseconds.

In some implementations, the individual 120 or 125 may move in relation to the mobile device 105 or 110. In this instance, the mobile device 105 or 110 may recalculate the time interval at which the mobile device 105 or 110 activates a receiver to receive any indications of data from the network 115. For example, the individual 125 may move to five meters away from the mobile device 110. The proximity sensor of the mobile device 110 may calculate that the individual 125 is greater than two meters from the mobile device 110. The mobile device 110 may adjust the time interval to five hundred milliseconds. Similarly, the individual 120 may move to within two meters of the mobile device 105. The proximity sensor of the mobile device 105 may calculate that the individual 120 is less than two meters from the mobile device 105. The mobile device 105 may adjust the time interval to one hundred milliseconds.

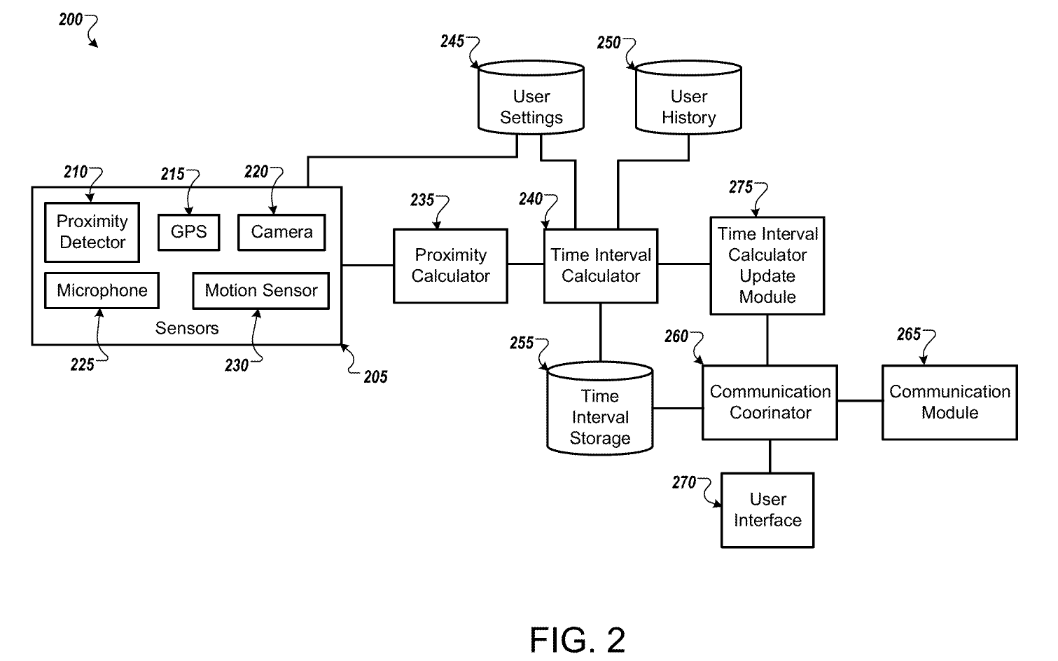

FIG. 2 is an example system 200 that is configured to adjust a time interval that the system 200 uses to communicate with a network. Briefly, and as described in more detail below, the system 200 processes sensor data to determine a proximity of an individual near the system 200. The system 200 updates a timing interval to communicate with the network to check if there is new data on the network for the system. The closer an individual is to the system 200, the lower the timing interval may be. To save battery battery power, the system 200 may increase the timing interval when an individual is farther from the system 200.

The system 200 includes sensors 205. The sensors 205 may include a proximity detector 210 that is configured to detect the presence of nearby individuals and objects without physical contact. The proximity detector 210 may generate a signal that is proportional to a distance between a nearby individual or object and the system 200. The sensors 205 may include a GPS 215. The GPS 215 may be configured to determine a location of the system 200. The sensors may include a camera 220. The camera 220 may capture video or photo data of the surrounding environment. The sensors 205 may include a microphone 225. The microphone 225 may be configured detect audio data from the surrounding environment. The sensors 205 may include a motion sensor 230. The motion sensor 230 may include an accelerometer to detect the acceleration of the system 200. The sensors 205 may include other sensors such as a gyroscope, compass, barometer, or any other similar sensors. A selection of the sensors 205 may be active when calculating the timing interval.

While the system 200 is in low power mode and checking the network for new data, the system 200 may limit the sensors 205 that are active to preserve battery life. For example, the system 200 may disable the GPS 215. In some implementations, the system 200 may limit the active sensors 205 based on a remaining battery life. For example, if the remaining battery life is less than thirty percent, then the system 200 may only activate the proximity detector 210. In some implementations, the system 200 may only use the proximity detector 210. In some implementations, the system 200 may use the sensors 205 specified by the user. For example, the user may specify that the system 200 should only activate the proximity detector 210 and the motion sensor 230. The user may specify to not activate the microphone 225, the GPS 215, or the camera 220.

The system 200 includes a proximity calculator 235. The proximity calculator 235 is configured to calculate a distance between the system 200 and an individual. In some instances, the individual may be outside the range of the sensors 205. The range of the sensors 205 may be known by the system 200. For example, the range may be ten meters. If the sensor data form the sensors 205 indicate that there are no individuals present, then the proximity calculator 235 may indicate that there is no individual within ten meters. In some implementations, the proximity calculator 235 may determine whether an individual is within two or more ranges. For example, two ranges may be between zero and five meters and between five meters and ten meters, where the sensors are unable to detect an individual farther than ten meters. In this case, the proximity calculator 235 may return that an individual is between five and ten meters from the system 200. As another example, the proximity calculator 235 may determine a more precise distance between an individual and the system 200. Based on the data from the sensors 205, the proximity calculator 235 determine that an individual is 0.5 meters from the system 200.

The proximity calculator 235 provides the distance or range that an individual is from the system 200 to the time interval calculator 240. The time interval calculator 240 calculates a time interval for the system 200 to check a network for data that the network is ready to deliver to the system 200. The time interval calculator 240 may compare the distance received from the proximity calculator 235 to a threshold distance. If the distance is below the threshold distance, then the time interval may be set to a time so that the nearby individual can quickly receive notifications of new data. If the distance is above a threshold, then the time interval may be set to a time to preserve battery life as there may not be an individual nearby to receive notifications of new data. The time interval calculator 240 may apply the distance received from the proximity calculator 235 to a function. The function may output a time interval based on the distance. For example, the distance may be one meter and the function may output one hundred milliseconds. The distance may be eight meters and the function may output eight hundred milliseconds. In some implementations, the time interval calculator 240 may receive a distance range from the proximity calculator 235. In this instance, the time interval calculator 240 may apply a step function that uses similar ranges to determine an appropriate time interval. The time interval calculator 240 may store the calculated time interval in the time interval storage 255.

In some implementations, the proximity calculator 235 determines the user proximity using the proximity detector 210. The proximity calculator 235 may determine based on data from the proximity detector 210 that a nearby object is moving. The proximity calculator 235 may make this determination while the motion sensor 230 indicates that the system 200 is stationary. In some implementations, the proximity detector 210 may be a passive infrared sensor that detects levels of heat emitted by nearby objects. The proximity calculator 235 may process the data from the passive infrared sensor and identify shapes, levels of heat, or movement of heat that may indicate the presence and proximity of an individual.

In some implementations, the proximity calculator 235 may determine user proximity based on detection of a wireless signal. In this instance, the proximity calculator 235 may communicate with the communication module 265 at a frequency to conserve battery power. As an example of detecting wireless signals, the proximity calculator 235 may communicate with the communication module 265 to detect short range radio signals transmitted from a smartwatch, activity tracker, or wireless headphones or speakers. The proximity calculator 235 may use the strength of the signal to estimate a distance that the user is from the system 200. In some implementations, the short range radio signals may include GPS data that indicate the location of the transmitting device. The proximity calculator 235 may access the GPS module 215 and compare the location of the system 200 with the location of the device transmitting the short range radio signal.

In some implementations, the proximity calculator 235 may use components (e.g., communication module 265) of the system 200 to detect signals from other systems. For example, the proximity calculator 235 may receive data indicating that a user of the system 200 is logged into a system that is located away from the system 200. The data may indicate the last time that the user interacted with the away system. The proximity calculator 235 may receive data indicating that the user of the system 200 recently provided voice input to another system. The proximity calculator 235 may compare the location of the away system to the location of the system 200. The proximity calculator 235 may receive data indicating that user of the system 200 completed a purchase at a different location using the away system or using a credit card. The proximity calculator 235 may compare data from GPS sensor 215 with location data of the purchase. The proximity calculator 235 may receive data indicating that a user interacted with a portion of the house (e.g., activate lights) that is away from the system 200. The proximity calculator 235 may compare the data from the GPS sensor 215 with the location of, for example, the activated lights to determine an estimated location of an individual. The system 200 may use any combination of the techniques described above to determine a likely distance between an individual and the system 200.

In some implementations, the time interval calculator 240 may access user settings 245 to calculate or adjust the time interval. The user settings 245 may include how frequently the user wishes to receive notifications. For example, the user may specify that the user wishes to receive notifications either frequently or infrequently. In this instance, the time interval calculator 240 may interpret the frequently or infrequently setting as a multiplier to apply to the calculated time interval. The time interval calculator 240 may apply a multiple of one to the calculated time interval for the frequently setting. The time interval calculator 240 may apply a multiple of five to the calculated time interval for the infrequently setting.

In some implementations, the time interval calculator 240 may access user history 250 to calculate or adjust the time interval. The user history 250 may include data related to the last time that the user interacted with the system 200, the last application that the user integrated with, and any other related context of the device. For example, if the user has not interacted with the system 200 in over an hour, then the time interval calculator 240 may apply a multiple of ten to the calculated time interval. If the user has interacted with the system 200 in less than a minute, then the time interval calculator 240 may apply a multiple of 0.5 to the calculated time interval.

The time interval calculator 240 may update the time interval stored in the time interval storage and accessed by the communication coordinator 260 as the time interval calculator 240 receives new proximity data form the proximity calculator 235. The communication coordinator 260 activates the communication module 265 to receive any communications the network may have for the system 200. The communication coordinator 260 may include a timer to provide instructions according to the time interval stored in the time interval storage 255. The communication module 265 may include a receiver that is configured to receive data communications from the network. The communication module 265 may also include a transmitter to transmit data to the network. The receiver and transmitter may be combined in a transceiver.

The communication module 265 may receive an indication of data available for the system 200. The communication coordinator 260 may instruct the communication module 265 to send a request for the data. In response, the network may transmit the data to the system 200. The communication coordinator 260 may display the data on the user interface 270.

In some implementations, the communication coordinator 260 may instruct the communication module 265 to transmit the time interval to the network. The communication coordinator 260 may instruct the communication module 265 if the network is an LTE network. The communication coordinator 260 may instruct the communication module 265 each time the time interval in the time interval storage 255 changes. The communication coordinator 260 may In instances where the network is a Wi-Fi network, the communication coordinator 260 may not notify the network of the time interval.

In some implementations, the communication coordinator 260 receives data related to the interactions that the user has with the user interface 270 and the timing of those interactions relative to the display of notifications or data received from the network. For example, the communication coordinator 260 may receive data from the user interface 270 that indicates that the user interacts with the system 200 between ten and sixty seconds when the communication coordinator 260 requests data at an interval of one hundred milliseconds. The communication coordinator 260 may receive data from the user interface 270 that indicates that the user interacts with the system 200 about between five and ten minutes when the communication coordinator 260 requests data at an interval of five hundred milliseconds. The communication coordinator 260 provide this interaction information to the time interval calculator update module 275.

The time interval calculator update module 275 may be configured to update the functions and ranges used by the time interval calculator 240. Following the example above, the time interval calculator update module 275 may adjust the function to increase the time interval of one hundred milliseconds. The time interval calculator 240 may set the time interval to one hundred milliseconds if an individual is within two meters of the system 200. The time interval calculator update module 275 may adjust that calculation such that if an individual is within two meters of the system 200, then the time interval may be set to three hundred milliseconds. The time interval calculator update module 275 may make this adjustment in view of the user not interacting with the system 200 until at least ten seconds when the time interval is set to one hundred milliseconds.

Similarly, the time interval calculator update module 275 may adjust the function to increase the time interval of five hundred milliseconds. The time interval calculator 240 may set the time interval to five hundred milliseconds if an individual is more than two meters from the system 200. The time interval calculator update module 275 may adjust that calculation such that if an individual is farther than two meters from the system 200, then the time interval may be set to two seconds. The time interval calculator update module 275 may make this adjustment in view of the user not interacting with the system 200 until at least five minutes when the time interval is set to five hundred milliseconds.

In some implementations, the time interval calculator update module 275 adjusts the time interval calculator 240 at a user specific level. For example, changes made to the time interval calculator on a system used by Alice may not affect the time interval calculator on a system used by Bob. In some implementations, different systems may share information. For example, changes made to the time interval calculator on a system used by Charles may affect the time interval calculator on a system used by Diane. In some implementations, the changes made to the time interval calculator on a system used by Charles may affect the time interval calculator on a system used by Diane if Chares and Diane are similar users. In some implementations, the time interval calculator update module 275 may use machine learning or neural networks to adjust the calculations of the time interval calculator 240.

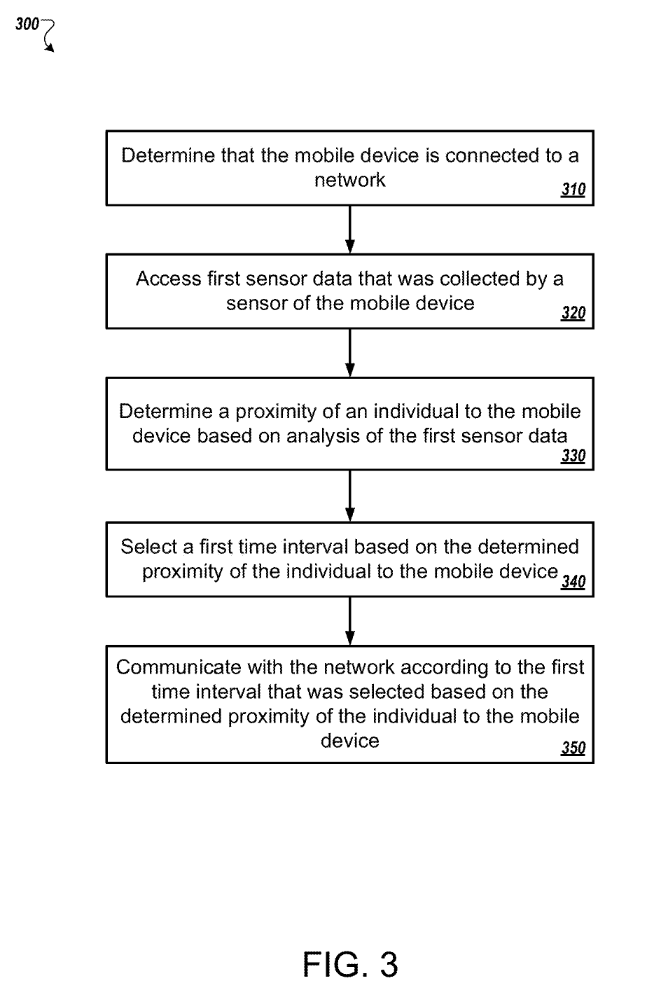

FIG. 3 illustrates an example process 300 for adjusting a time interval that a mobile device communicates with a network. In general, the process 300 determines the proximity of an individual to a mobile device. The process 300 adjusts, based on the proximity of the individual, a time interval at which the mobile device checks the network for new data. The process 300 will be described as being performed by a computer system comprising one or more computers, for example, the computing devices 105 or 110 as shown in FIG. 1 or the computing system 200 as shown in FIG. 2.

The system determines that the system is connected to a network (310). In some implementations, the network is a Wi-Fi network. In some implementations, the network is a LTE or other type of cellular network. In some implementations, the system is operating in low power mode while performing process 300, and process 300 may not otherwise be performed if the system was not operating in low power mode such that the proximity of a mobile device may not affect the time interval at which the mobile device checks the network for new data. Low power mode may include the screen not being on and the wireless communication modules not being active unless otherwise noted in the process 300.

The system accesses first sensor data that was collected by a sensor of the system (320). In some implementations, the sensor is a proximity sensor. The proximity sensor detects the presence of nearby individuals or other objects. In some implementations, the system may access data from other sensors. The other sensors may include any combination of GPS, camera, motion sensor, microphone, and any other similar sensors. In some implementations, one or more of these sensors may not be active because the system is in low power mode and/or because the user settings indicate not to access particular sensor data unless the user has specifically authorized usage of that sensor's data.

The system determines a proximity of an individual to the system based on analysis of the first sensor data (330). The system may determine an approximate distance that the individual is from the system. For example, the system may determine, based on the proximity sensor data that the user is one meter from the system. As another example, the system may determine that there are no individuals detected by the proximity sensor. The proximity sensor may have a detection limit. If no individuals are detected, then that may indicate that no individuals are within, for example, ten meters of the system.

The system selects a first time interval based on the determined proximity of the individual to the system (340). In some implementations, the system may compare the approximate distance that the individual is from the system to a threshold distance. For example, the system may compare the approximate distance to a threshold distance of two meters. In some implementations, the system may not calculate an approximate distance. Instead, the system may use the data from the sensor data to determine if an individual is within a threshold distance or outside of a threshold distance of from the system.

If the system determines that an individual is within a threshold distance, then the system may select a time interval that will allow the individual to quickly receive notification of new data. This time interval may be one hundred milliseconds. If the system determines that individual is outside of the threshold distance, then the system may select a time interval that will save battery power as there may not be an individual near the system. An individual who is not within the threshold distance of the system may not be able to see or hear a notification of new data or may not be interested in immediately receiving the notification. As such, the system may set the time interval to five hundred milliseconds.

In some implementations, the system may select the time interval by applying a function to the approximate distance that the individual is from the system. For example, the function may be a function that receives the approximate distance that the individual is from the system and outputs a time interval. The function may be a monotonically increasing function. In other words, as the approximate distance increases, the time interval increases. The function may be a linear function, a logarithmic function, an exponential function, or any other type of monotonically increasing function. The function may also be an increasing step function.

The system communicates with the network according to the first time interval that was selected based on the determined proximity of the individual to the system (350). In some implementations, before the system communicates with the network according to the first time interval, the system transmits to the network, the first time interval. For example, if the network is an LTE network, then the system may transmit the time interval to the network before receiving data from the network according to the time interval. Transmitting the time interval to the network can enable the network to transmit to the system according to the time interval.

In some implementations, the system communicates with the network by activating a receiver of the system to receive data transmitted to the system over the network. For example, the network may transmit data indicating that the system has a message waiting on the network. The system may have to actively receive that transmission in order to begin requesting and processing the message.

In some implementations, the system determines that the network has data for the system. The system transmits a request to the network for the data, and the network transmits the data to the system. The system then processes the data and, if necessary, outputs a notification that the system received the data.

In some implementations, the system may access additional sensor data from the same sensor. For example, the system may access additional data from the proximity detector. The system may process the additional data and determine that an individual is approximately three meters from the system. If three meters is different than the initial proximity, then the system may select a different time interval. The system may communicate with the network according to the different time interval.

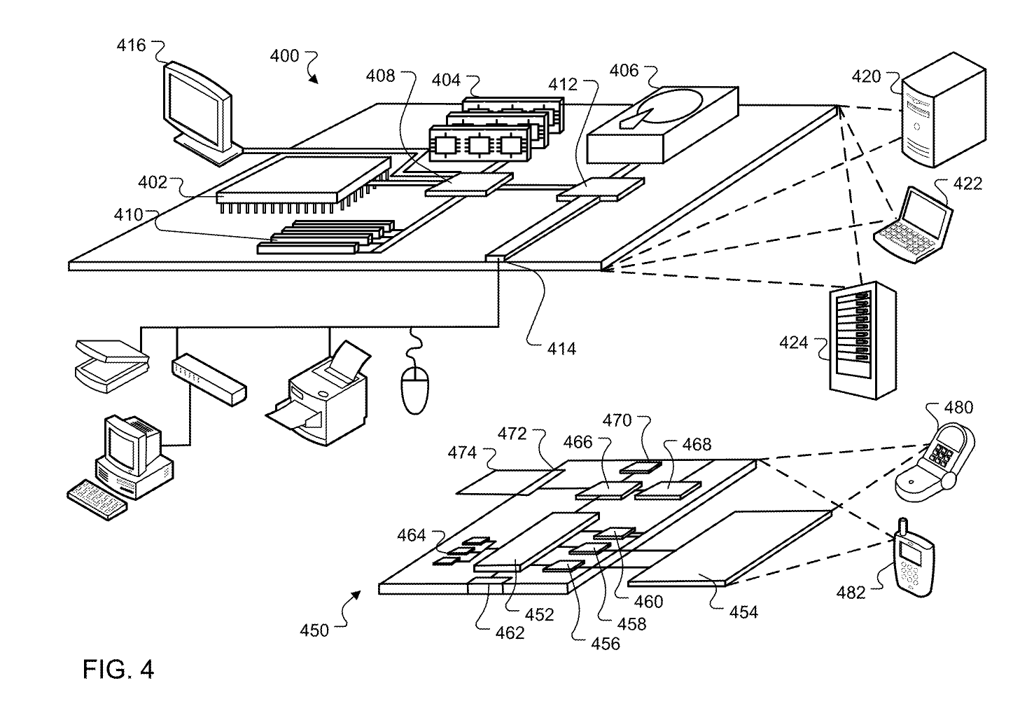

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, wireless (e.g., Bluetooth) headsets, hearing aid, smart watches, smart glasses, activity trackers, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, a microphone, speakers, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a touch-enabled display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method comprising:
periodically activating a radio of a mobile device to communicate with a network and determine whether the network has data queued for transmission to the mobile device, the periodical activation occurring at a first frequency of periodical activations;
accessing, by the mobile device, first sensor data that was collected by a sensor of the mobile device;
determining, by the mobile device, a user proximity to the mobile device based on analysis of the first sensor data;
adjusting, by the mobile device, the mobile device from periodically activating the radio at the first frequency of periodical activations to periodically activating the radio at a second frequency of periodical activations, based on the determined user proximity to the mobile device; and
determining, by the mobile device, whether the network has data to transmit to the mobile device by periodically activating the radio of the mobile device to communicate with the network according to the second frequency of periodical activations.

2. The computer-implemented method of claim 1, comprising:
accessing, by the mobile device, second sensor data that was collected by the sensor of the mobile device;
determining, by the mobile device, a second user proximity to the mobile device based on analysis of the second sensor data;
adjusting, by the mobile device, the mobile device from periodically activating the radio at the second frequency of periodical activations to periodically activating the radio at a third frequency of periodical activations, based on the determined second user proximity to the mobile device; and
based on the determined second user proximity to the mobile device, determining, by the mobile device, whether the network has data to transmit to the mobile device by periodically activating the radio of the mobile device to communicate with the network according to the third frequency periodical activations.

3. The computer-implemented method of claim 2, wherein:
determining the second user proximity to the mobile device based on analysis of the second sensor data comprises:
determining that the second user proximity is less than a threshold proximity, and
adjusting the mobile device from periodically activating the radio at the second frequency of periodical activations to periodically activating the radio at the third frequency of periodical activations, based on the determined second user proximity to the mobile device comprises:
adjusting the mobile device from periodically activating the radio at the second frequency of periodical activations to periodically activating the radio at the third frequency of periodical activations, based on determining that the second user proximity is less than the threshold proximity.

4. The computer-implemented method of claim 1, wherein:
determining the user proximity to the mobile device based on analysis of the first sensor data comprises:
determining that the user proximity is greater than a threshold proximity, and
adjusting the mobile device from periodically activating the radio at the second frequency of periodical activations to periodically activating the radio at the third frequency of periodical activations, based on the determined user proximity of the individual to the mobile device comprises:
adjusting the mobile device from periodically activating the radio at the second frequency of periodical activations to periodically activating the radio at the third frequency of periodical activations, based on determining that the user proximity is greater than the threshold proximity.

5. The computer-implemented method of claim 1, wherein adjusting the mobile device from periodically activating the radio at the second frequency of periodical activations to periodically activating the radio at the third frequency of periodical activations is performed by utilizing a function that receives as input the determined user proximity and outputs a time interval value.

6-7. (canceled)

8. The computer-implemented method of claim 1, wherein:
determining whether the network has data to transmit to the mobile device comprises determining that the network has data to transmit to the mobile device, and
the method comprises:
transmitting, by the mobile device and to the network, a request for the data; and
receiving, by the mobile device, the data.

9. The computer-implemented method of claim 1, comprising:
before communicating with the network according to the first frequency of periodical activations, transmitting, by the mobile device and to the network, an indication of the first frequency of periodical activations to cause a computing system associated with the network to transmit pages according to the first frequency of periodical activations.

10. The computer-implemented method of claim 1, wherein the sensor comprises a proximity sensor.

11. The computer-implemented method of claim 1, wherein:
the mobile device is in a low power mode,
the mobile device adjusts the mobile device from periodically activating the radio at the first frequency of periodical activations to periodically activating the radio at the second frequency of periodical activation, based on the mobile device being in the low power mode, and
the mobile device communicates with the network according to the second frequency of periodical activations based on the mobile device being in the low power mode.

12. The computer-implemented method of claim 1, wherein communicating with the network according to the second frequency of periodical activations comprises:
repeatedly activating the radio of the mobile device to receive data transmitted to the mobile device over the network,
wherein a time period between activations of the radio of the mobile device is an inverse of the second frequency, and
wherein the radio of the mobile device is inactive between activations.

13. A system comprising:
one or more computers; and
one or more storage devices storing instructions that are operable, when executed by the one or more computers, to cause the one or more computers to perform operations comprising:
periodically activating a radio of a mobile device to communicate with a network and determine whether the network has data queued for transmission to the mobile device, the periodical activation occurring at a first frequency of periodical activations;
accessing, by the mobile device, first sensor data that was collected by a sensor of the mobile device;
determining, by the mobile device, a user proximity to the mobile device based on analysis of the first sensor data;
adjusting, by the mobile device, the mobile device from periodically activating the radio at the first frequency of periodical activations to periodically activating the radio at a second frequency of periodical activations, based on the determined user proximity to the mobile device; and
determining, by the mobile device, whether the network has data to transmit to the mobile device by periodically activating the radio of the mobile device to communicate with the network according to the second frequency of periodical activations.

14. The system of claim 13, wherein the operations further comprise:
accessing, by the mobile device, second sensor data that was collected by the sensor of the mobile device;
determining, by the mobile device, a second user proximity to the mobile device based on analysis of the second sensor data;
adjusting, by the mobile device, the mobile device from periodically activating the radio at the second frequency of periodical activations to periodically activating the radio at a third frequency of periodical activations, based on the determined second user proximity to the mobile device; and
based on the determined second user proximity to the mobile device, determining, by the mobile device, whether the network has data to transmit to the mobile device by periodically activating the radio of the mobile device to communicate with the network according to the third frequency periodical activations.

15. The system of claim 13, wherein adjusting the mobile device from periodically activating the radio at the second frequency of periodical activations to periodically activating the radio at the third frequency of periodical activations is performed by utilizing a function that receives as input the determined user proximity and outputs a time interval value.

16. (canceled)

17. The system of claim 13, wherein the operations further comprise:
before communicating with the network according to the first frequency of periodical activations, transmitting, by the mobile device and to the network, an indication of the first frequency of periodical activations to cause a computing system associated with the network to transmit pages according to the first frequency of periodical activations.

18. The system of claim 13, wherein:
the mobile device is in a low power mode,
the mobile device adjusts the mobile device from periodically activating the radio at the first frequency of periodical activations to periodically activating the radio at the second frequency of periodical activation, based on the mobile device being in the low power mode, and
the mobile device communicates with the network according to the second frequency of periodical activations based on the mobile device being in the low power mode.

19. The system of claim 13, wherein communicating with the network according to the second frequency of periodical activations comprises:
repeatedly activating the radio of the mobile device to receive data transmitted to the mobile device over the network,
wherein a time period between activations of the radio of the mobile device is an inverse of the second frequency, and
wherein the radio of the mobile device is inactive between activations.

20. A non-transitory computer-readable medium storing software comprising instructions executable by one or more computers which, upon such execution, cause the one or more computers to perform operations comprising:
periodically activating a radio of a mobile device to communicate with a network and determine whether the network has data queued for transmission to the mobile device, the periodical activation occurring at a first frequency of periodical activations;
accessing, by the mobile device, first sensor data that was collected by a sensor of the mobile device;
determining, by the mobile device, a user proximity to the mobile device based on analysis of the first sensor data;
adjusting, by the mobile device, the mobile device from periodically activating the radio at the first frequency of periodical activations to periodically activating the radio at a second frequency of periodical activations, based on the determined user proximity to the mobile device; and
determining, by the mobile device, whether the network has data to transmit to the mobile device by periodically activating the radio of the mobile device to communicate with the network according to the second frequency of periodical activations.
